(19) United States
(12) Patent Application Publication
(10) Pub. No.: US 2016/0046835 A1
(43) Pub. Date: Feb. 18, 2016

(54) ANTI-CORROSIVE, WEAR RESISTANT AND ANTI-UV COATING FOR THERMAL TRANSFER, AND PREPARATION METHOD AND APPLICATION OF THE SAME

(71) Applicant: UCDISPLAY , LLC, Fremont, CA (US)

(72) Inventors: Yanqiang Ye, Fremont, CA (US); Chih-Cheng Tai, Campbell, CA (US); Lei Li, Beijing (CN); Zhixiang Wu, Beijing (CN); Wenjun Liao, Beijing (CN)

(73) Assignee: UCDISPLAY, LLC

(21) Appl. No.: 14/825,002

(22) Filed: Aug. 12, 2015

(30) Foreign Application Priority Data
Aug. 14, 2014 (CN) 201410399859.4

(51) Int. Cl. C09D 175/04; C08K 3/22; C08K 3/36

(52) U.S. Cl. CPC C09D 175/04; C08K 3/36; C08K 3/22; C08K 2003/2227; C08K 2003/2244

(57) ABSTRACT

An anti-corrosive, wear-resistant, and UV-blocking/absorbing coating for dye sublimation, the preparation method thereof, and the application thereof are provided. The coating for dye sublimation includes the following compositions, in parts by weight: 70 to 99 parts of polyurethane, 0.4 to 10 parts of inorganic nano silicon oxides, 0.3 to 10 parts of inorganic nano aluminum oxides, and 0.3 to 10 parts of inorganic nano zirconium oxides.

### CROSS-REFERENCE TO RELATED APPLICATION(S)

The present invention claims priority to the Chinese patent application Ser. No. 201410399859.4, titled “ANTI-CORROSIVE, WEAR RESISTANT AND ANTI-UV COATING FOR THERMAL TRANSFER, AND PREPARATION METHOD AND APPLICATION OF THE SAME,” filed on Aug. 14, 2014, which is incorporated by reference in its entirety for all purposes.

### FIELD OF THE INVENTION

The present invention relates to a dye sublimation coating and the preparation method thereof. In particular, the present invention relates to an anti-corrosive, wear resistant and UV-retardant coating for dye sublimation, as well as the preparation method and the application thereof.

### BACKGROUND OF THE INVENTION

Sublimation is a dye transfer method forcing/making the pigment molecules into the medium by heating. Ways to achieve the sublimation include sublimation printers, sublimation transfer papers, and sublimation inks.

As used herein, the term “sublimation transfer” means that, images are digitalized by a digital camera or a scanner, and a professional database thereof, image-processed and designed by a computer to produce a gorgeous and exquisite image as desired, printed, according to the images as designed by the computer, onto base papers with the ink by an inkjet printer that is loaded with ink for sublimation use, and then transferred onto the products such as dishes and shirts through heating by the mug press, plate press, or heat transfer machine for several minutes.

1. The fabrication of sublimation transfer printing papers:

The fabrication process of sublimation transfer printing papers is similar to the digital color inkjet proofing system. That is, the graphics or photos to be dye sublimated are processed and designed by the computer, and are printed onto the base paper with the use of digital inkjet printer. The digital inkjet printer is equipped with four separate cartridges of yellow, magenta, cyan and black, or with more cartridges of various colors, such that either monochrome images or color images is printed on the base paper as desired. Such inkjet printers save the proofing procedures, reduce the fabrication costs, and make the dye sublimation process more simplified.

2. Dye sublimation of patterns onto the products such as cups, dishes and plates:

By the use of mug press that is electronically and digitally controlled, the patterns on the sublimation transfer printing papers can be transferred onto a cup in minutes. The materials that need to make nice and full-color images on the surface of cup, by the use of mug press, are simply transfer inks and a cup coated with a sublimation coating, and the operation process thereof is easy and convenient.

By the use of plate press that is electronically and digitally controlled, the patterns on the sublimation transfer printing papers can be transferred onto the dish in minutes. Equipped with transfer inks, the plate press makes it possible to produce various patterns on a special dish.

Heat transfer printers, electronically and digitally controlled, are used to transfer the patterns from the sublimation transfer printing papers onto a ceramic plate or a metal plate in minutes. It is suitable for the production of medals, honorary certificates, plaques, and portrait porcelain.

### SUMMARY OF THE INVENTION

One aspect of the present invention provides a coating for dye sublimation and the preparation method thereof. In some embodiments, the present invention provides an anti-corrosive, wear-resistant, and UV blocking/absorbing coating for dye sublimation, as well as the preparation method and the application thereof. The present invention overcomes the shortcomings of single function and image instability caused by the coating of the typical technique, and is advantageous in wear-resistance, scratch-resistance, anti-corrosion and UV blocking/absorbing effects.

The present invention includes the use of the following principles:

In view of the image instability issues caused by the coatings of purely organic raw materials, or with a rare amount of inorganic additives, that are commonly used in the existing technique to achieve the dye sublimation effect, some embodiments of the present invention use inorganic compositions and a predetermined mixing ratio thereof to provide the stability of the coating and/or images. In addition, the present invention provides the features of wear-resistance, scratch-resistance, corrosion-resistance and UV protection, and effectively extends the life of the dye sublimation product. The present invention makes it possible for the dye sublimation process to be applied in a wide range of applications and conditions. In some embodiments, the dye sublimation process and composition disclosed herein can be used in a thermal transfer process.

In some embodiments, an anti-corrosive, wear-resistant, and UV blocking/absorbing coating for dye sublimation comprises the following compositions in parts by weight: 70 to 99 parts of polyurethane, 0.4 to 10 parts of inorganic nano silicon oxides, 0.3 to 10 parts of inorganic nano aluminum oxides, and 0.3 to 10 parts of inorganic nano zirconium oxides.

In other embodiments, the anti-corrosive, wear-resistant, and UV blocking/absorbing coating for dye sublimation comprises the following compositions in parts by weight: 80 to 90 parts of polyurethane, 2 to 4 parts of inorganic nano silicon oxides, 2 to 4 parts of inorganic nano aluminum oxides, and 2 to 4 parts of inorganic nano zirconium oxides.

The inorganic nano silicon oxides, the inorganic aluminum oxides, and the inorganic zirconium oxides are ultra-fine particles with a particle size of 200 nm or less, and preferably, with a particle size of 15 nm or less.

In some embodiments, the anti-corrosive, wear-resistant, and UV blocking/absorbing coating for dye sublimation of the present invention is a transparent film.

The anti-corrosive, wear-resistant, and UV blocking/absorbing coating for dye sublimation further comprises a predetermined amount of solvent including water or volatile solvent, wherein the volatile solvent is able to be an alcohol, toluene, xylene, acetone, cyclohexanone, butanone. The alcohols are able to be ethanol, propanol, propanediol, and iso-propanol. A person of ordinary skill in the art appreciates that any other organic or inorganic solvents are able to be used, such as a solvent with one or more —OH functional groups.

In some embodiments, the coating for dye sublimation of the present invention comprises an ink layer having a pattern printed thereon, which is attached to a surface of an object with the coating for dye sublimation after being hot-pressed.

The composition of the ink is able to be based on a predetermined ratio or is commercially available.

In some embodiments, the adhesive of polyurethane is a transparent formulation of high adhesion, and the coating made thereof is advantageous in excellent wear-resistance, water-resistance, and chemical-resistance. The coating has a good anti-corrosive ability for not being damaged by a variety of acids, bases and organic solvents. In some embodiments, the polyurethane used is commonly used in the industrial printing ink. Coatings made of such polyurethane is soft and flexible, has a good strength, and can be applied as very thin coatings. Such coatings are porous, moisture-permeable, ventilate, wear-resistant, water-resistant, and dry wash-resistant.

In some embodiments, three nano composite inorganic materials are selected and used to improve the property of polyurethane in the coatings.

In some embodiments, the nano silicon oxides added, xy-g01, also called “fumed silica,” has a primary particle size ranged from 70 to 80 nanometers, and a specific surface area of generally are greater/larger than 100 m²/g.

In some embodiments, the nano silicon oxides added are uniformly dispersed within the matrix, which can enhance the properties of wear-resistance and matting effect, while keeping the transparency of the coating. Nano silicon oxides (SiO₂) provide the effects of dispersion and flow rate control for the ink.

The nano silicon oxides are non-toxic, tasteless, odorless, and non-polluting non-metal oxides exhibiting the properties of high strength, high toughness, and good stability under a high temperature condition.

As the nano SiO₂ has a small size effect and a surface-interface effect, the suspension of pigments can be improved, and the color of coatings does not fade and can be maintained for a long time. The strength and finish of the coatings are increased, and the ability to resist the contamination thereof is enhanced. Thus, the coatings have excellent properties of self-cleaning and adhesion. The use of nano SiO₂ with the organic pigments results in a photochromic coating, and enhances the flexibility and strength of the coatings.

Nano silicon oxides exhibit special optical properties that the typical big size SiO₂ particle does not have. Nano silicon oxides have strong properties of UV absorption and infrared reflection. The analysis by UV-visible spectrophotometer indicates that, nano silicon oxides have an UV absorption, e.g. the wavelength of 400 nm or less, of higher than 70%, and an infrared reflection, e.g. the wavelength other than 800 nm, of higher than 70%. Accordingly, the use of nano silicon oxide makes the coating having a shielding effect, and the functions of resisting/preventing UV aging and heat aging are achieved. Meanwhile, the thermal insulation property of the coatings is improved. The use of nano silicon oxides can significantly reduce the coatings' absorption of UV radiation.

In some embodiments, different types of nano aluminum oxides are used including the χ-type, β-type, η-type and γ-type aluminum oxides, as well as the κ-type, δ-type, θ-type aluminum oxides, and α-Al₂O₃, wherein the α-Al₂O₃ comprises inactive aluminum oxides which has a small specific area and is heat-resistant even under a high temperature up to 1100° C. β-Al₂O₃ and γ-Al₂O₃ have a relatively larger specific area, high porosity, strong heat-resistance, and good formability. β-Al₂O₃ and γ-Al₂O₃ have stronger surface acidity and a certain surface alkalinity, and are “green” adhesives for carriers. The primary particle size of β-Al₂O₃ and γ-Al₂O₃ is 20 nm, and the specific area thereof is 230 m²/g or more. The β-Al₂O₃ and γ-Al₂O₃ have a uniform particle size distribution, high purity, a good ability in dispersing, large specific area, good heat-resistance, high activity, and are active aluminum oxides. Because of the size stability of β-Al₂O₃ and γ-Al₂O₃, they are able to disperse well and uniformly, without adding any dispersion agent, by slightly stirring.

The material properties/features of a material disclosed herein throughout the present specification are able to enhance a product to have/enhance/possess such properties when incorporate/using such material. For example, when a coating includes β-Al₂O₃, such coating can have properties of high porosity, strong heat-resistance, and good formability.

The use of nano Al₂O₃ in the coating for high quality inkjet printing paper provides high gloss and excellent property of printing, and improves the property of anti-corrosion for the coating.

In some embodiments, the nano zirconium oxides used has a melting point of 2397° C. and a boiling point of 4275° C. The nano zirconium oxides have properties of good thermal shock resistance, good heat-resistance, and good chemical stability, and are good at forming composite materials. In some embodiments, the composite formed of nano zirconium oxides, Al₂O₃ and SiO₂ significantly improves the properties of the material, and enhances the fracture toughness and the flexural strength thereof. Accordingly, the nano zirconium oxides, when being added into the coating, can avoid damage the surface of carrier, and provide the carrier with the properties such as thermal conduction, thermal shock resistance, and high temperature oxidation resistance. Such coating is able to be applied to the surface of structural ceramics, functional ceramics and metals.

In some embodiments, polyurethane (PU) is selected to be used as the major composition of the coating (e.g., equal or greater than 50% of the entire composition, >60%, between 50%-70%, >90%, >95%, or >99%). The addition of inorganic nano silicon oxides, inorganic nano aluminum oxides, and inorganic nano zirconium oxides into the polyurethane, using the above-mentioned compositions and ratios, introduces an excellent synergistic effect, and thereby the ink pattern is able to be well/firmly/securely attached. In some embodiments, during the image/pattern transferring process, the combined properties' effects of these three oxides enhances/forms the synergistic material properties of each of the oxides and further ensuring the clearness of pattern as printed. In some embodiments, the coating has functions of wear-resistance, high temperature-resistance, anti-corrosion and UV blocking/absorbing property, and provides, especially for the surface attached to a carrier, the protection.

In comparison with the conventional coating, which needs to be formed of different compositions and ratios depending on the various carriers, the coating of the present invention is advantageous in that, the compositions of the coating is suitable for various materials of carriers for printing use.

In some embodiments, the preparation method of the mentioned anti-corrosive, wear-resistant, and UV blocking/absorbing coating for dye sublimation is disclosed. The method includes the steps of preparing polyurethane, and the step of adding and mixing the inorganic nano silicon oxides, inorganic nano aluminum oxides and inorganic nano zirconium oxides into said polyurethane according to the disclosed compositions and ratios.

The method further includes printing a predetermined pattern on the anti-corrosive, wear-resistant, and UV blocking/absorbing coating for dye sublimation with a transfer ink, and transferring the pattern onto a surface of an object to complete the process of printing under a condition of high temperature and high pressure. In some embodiments, the dye sublimation is performed under a temperature of 100 to 260° C. and a pressure of 0.5 to 1.5 Kpa/s for 30 to 1200 seconds.

In some embodiments, the ink includes the compositions of N-methoxymethyl polyamide, 19% of benzyl alcohol, 40% of toluene, 17% of ethanol, 6% of bentonite, and 9% of pigments. The N-methoxymethyl polyimide is dissolved in the solvent of benzyl alcohol, toluene, and ethanol, and then the thermal resistant pigments and bentonite are added therein under stirring. These compositions are ground, thereby forming the printing ink. Patterns are able to be printed on the coating of the present invention with the use of such ink, and are transferred, through a typical thermal transfer method (as an example), onto the surface of a carrier made of glass, ceramics, metal or wood, for example.

The coatings for dye sublimation according to some embodiments of the present invention have properties of strong sense of color, anti-corrosion, acid and alkali-resistance, UV blocking/absorbing, waterproof, and scratch-resistance. The image formed thereby has a high clarity, bright color, and never fades. Such coatings can be widely used in a variety of industries, including home building industry, ceramics, glass, metals, resins, and coatings industry, and a variety of products such as various ABS, PP, plastics, woods, and coated-metals.

In some embodiments, the present invention enables the anti-corrosive, wear-resistant, and UV blocking/absorbing coating for dye sublimation as mentioned to be applicable onto a product made of glass, ceramics, or metal. Compared to the conventional technique, the present invention achieves the following technical effects by utilizing the mentioned technical methods:

1. Using a unique formula of raw materials and compositions, the dye sublimation coating and the image as formed are both provided with anti-corrosion, UV blocking/absorbing, wear-resistance, and scratch-resistance functions.

2. It is able to perform the dye sublimation on the product made of ceramics, metals, crystals, plastics such as ABS, AS, PS, PVC, EVA, PP, and PE, leather, textile fabrics, woods, and coated papers of flat, curved, shaped, cylindrical, and conical surface. The product has advantages of good adhesion, wear-resistance, sun-proof, high image fidelity, and color brightness. Besides, it enables the multicolor printing with simplified procedures, increased efficiency, and reduced cost, and brings no containments to the environment.

3. In particular, the present invention makes it possible to perform the dye sublimation directly on the surface of product made by ceramics, metals or glass under a high temperature of approximately 200° C. As to the conventional thermal transfer process, it requires to carry out a specific treatment for the coating before performing the thermal transfer.

### BRIEF DESCRIPTION OF THE DRAWINGS

FIG. 1 illustrates an individualized printing building material method 100 in accordance with some embodiments of the present invention.

FIG. 2 is a flow chart illustrating a method 200 of customizing a building material in accordance with some embodiments of the present invention.

FIG. 3 illustrates a method 300 of making building materials for a wall with an image or a predesigned pattern in accordance with some embodiments of the present invention.

### DETAILED DESCRIPTION OF THE PREFERRED EMBODIMENTS

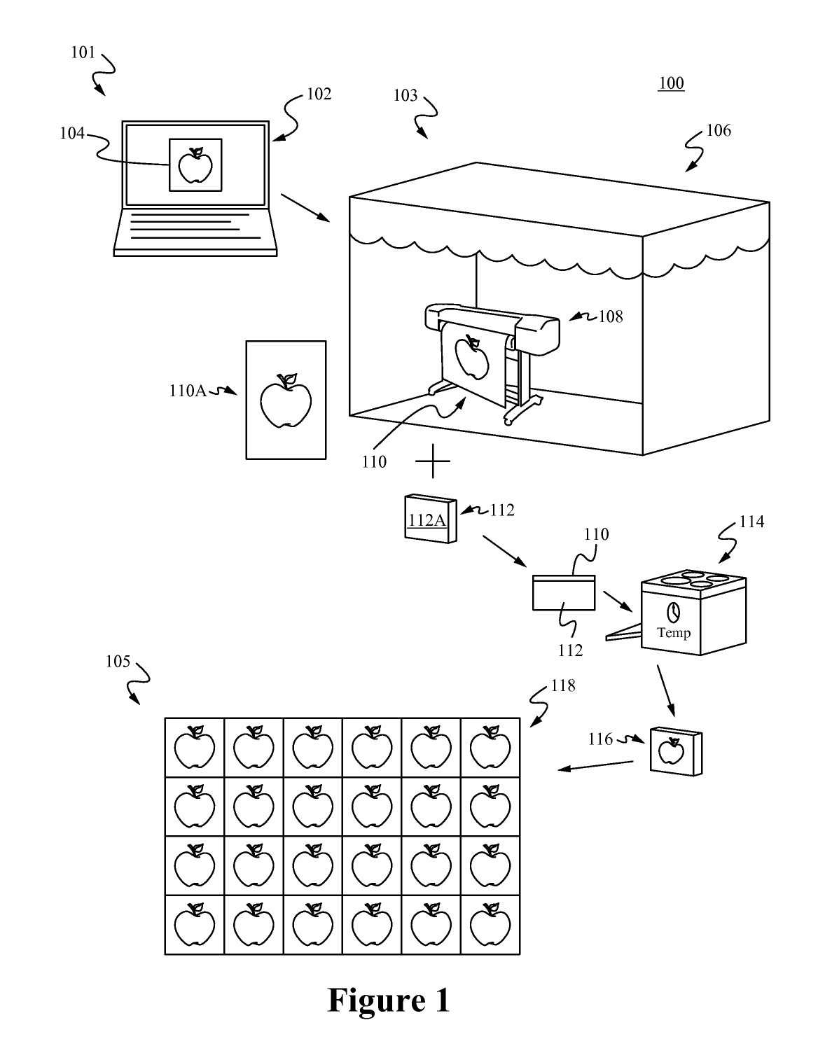

FIG. 1 illustrates an individualized printing building material method 100 in accordance with some embodiments of the present invention. At a Step 101, one or more predetermined designs 104 are able to be performed on a computing device 102. In some embodiments, the designs 104 is performed by a designer (such as an interior designer and a graphic designer). In some embodiments, the designs are performed on a designing software on a computer, such as a home use laptop. In some embodiments, the design is performed on a website hosted by a server while accessible by a client device, such as a home use computer or a smart phone. A computer software is able to be used to assist the design of the predetermined designs 104. The designs 104 can comprise a graphic figure and or texts. In some embodiments, the designs 104 comprises a color tone number or color profile, which can be sent as independent signal/information via internet or wirelessly.

In some embodiments, a database comprises a library of designs of pictures, design patterns, and/or graphic patterns is offered for a designer or consumer to choose from. The library of designs can be included in a software, a web based version, or on the computer of a retail store. The computing device 102 and or the library can connect with a computer/ server at a printing facility 106 allowing instant design and instant print function.

In some embodiments, the color tone or color number (such as Pantone® color 348, green) is sent to a printing facility 106. In some other embodiments, a graphic design is divided into 1,000 zones/data points. Each of the color numbers and lighting color/intensity (lighting environmental of a design) at each zone/point is able to be recorded and transmitted to a printing facility for printing. For example, zone 1 has a Pantone red 176, zone 2 has a Pantone red 177, and zone 3 has a Pantone red 178, such that a gradient red color wall is able to be printed using the method disclosed herein.

In some embodiments, a color capturer, colorimeter, or scanner is able to be used to scan a physical location/area to determine one or more colors/patterns/figures/pictures (such as Pantone® red 1797) of the location/area, such that the colors/patterns/figures/pictures can be printed/reproduced on a building material (e.g., tiles and/or glass shower doors) and/or any printable objects (e.g., a table top coated a polyurethane based coating; a dye sublimation coating). In some embodiments, the color matching can be done by determining a color of a material (such as by using the scanner), a building material can be printed with the specific color for a function of color matching.

At a Step 103, the one or more designs 104 are sent to a printing facility 106, such that a printed building material 116 is able to be made. In some embodiments, the printing facility is a retail store, such as Home Depot®, Lowe's®, Ace hardware®, B&Q®, DIY stores®, online store or e-commerce and/or any other home improvement stores. In other embodiments, the printing facility comprise a printing fulfilling center or manufacturing factory. In some other embodiments, the printing facility comprises consumer based printing machines that can be used at home.

In some embodiments, a printer 108 is used to print the designs 104/graphic patterns on a polymeric film 110, such as polyethylene terephthalate (PET) coated with silica, which can withstand a temperature about or higher than 160° C. In some embodiments, the PET based film is used for polycarbonate (PC) based subject products (e.g., a cell phone protective case). In other embodiments, a printer 108 is used to print the designs 104/graphic patterns on a sublimation paper 110A sealed on one side. The polymeric film 110 and/or the sublimation paper 110A is coupled with/attached to a printing object 112. In some embodiments, the attachment of the polymeric film 110 and/or the sublimation paper 110A with the printing object 112 is further enhanced by vacuum, generating an amount of a static force/friction, or an external applied pressure pushing the film 110/paper 110A against the printing object 112.

In some embodiments, the printing object 112 comprises a sublimation coating (e.g., the polyurethane based coating disclosed in the present specification). The printing object 112 can be a tile, a wood table top, aluminum, marble, cell phone protective case, glass, and/or any other building materials or surfaces of consumer electronics.

After the printing object 112 is secured with the film 110/paper 110A, an oven or a temperature is applied for the dye/image on the film 110/paper 110A to be sublimated and transferred to the coating of the printing object 112 forming a printed product 116.

At a Step 105, the printed product 116 (e.g., printed building materials) are applied on a building structure 118 (e.g., a wall).

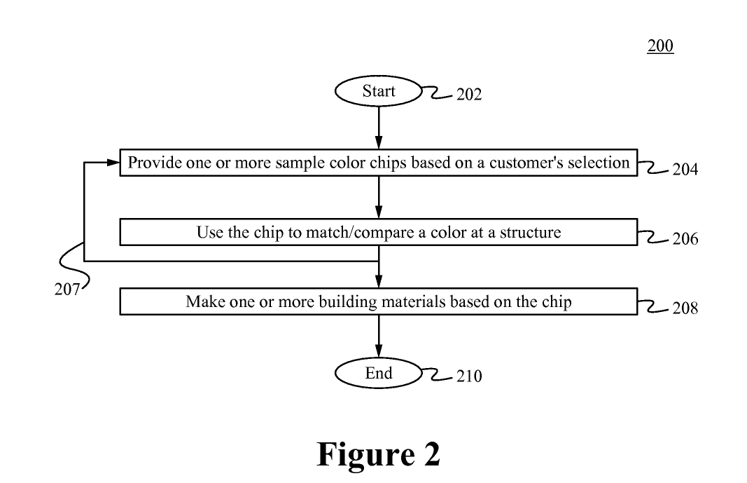

FIG. 2 is a flow chart illustrating a method 200 of customizing a building material in accordance with some embodiments of the present invention. The method can start at a Step 202. At a Step 204, one or more sample color chip is provided based on a customer's color selection. In some embodiments, the chip is provided in a building material retail store, such as Home Depot®. The retail store can provide a printer and/or an oven within the store. A customer can pick a color from a Panton® color book. For example, Pantone® orange color 159 can be selected because the customer is a fan of SF Giants baseball team. A store clerk of the retail store based on a color profile stored in their computer system or accessible based on a web based user interface (UI) command the printer to print the orange color (Panton 159) on a sublimation paper. The sublimation paper is attached to the sample color chip with a blank coating. The sublimation paper and the chip with blank coating are placed in the oven at a predetermined temperature for a predetermined duration (such as 140° C. for 5 minutes), such that the color on the sublimation paper is transferred onto the chip. The chip becomes a printed chip with the orange color (Panton 159).

At a Step 206, the customer can bring the chip home to match/compare the color of a structure, such as a wall of her home.

At a Step 207, if the customer does not satisfy with the color, the method 200 goes back to the Step 204, such that another sample chip with different color can be prepared.

At a Step 208, if the customer decides to purchase products (such as tiles with the orange color e.g., Pantone® 159, the retail store is able to make a predetermined quantity (e.g., 30 pieces) of the building materials using the color chip or the color information on/about the color chip via the sublimation system and the coated blank building materials. In some embodiments, the retail store is able to send the information back to a factory or fulfill facility to make the building material based on the customer' selected color. The method 200 can stop at a Step 210.

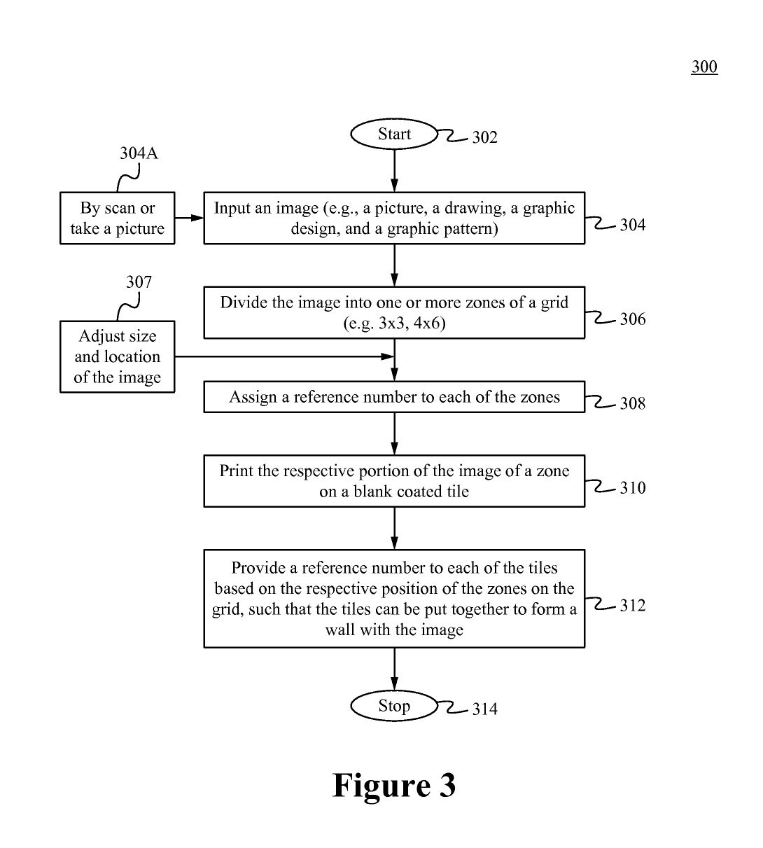

FIG. 3 illustrates a method 300 of making building materials for a wall with an image or a predesigned pattern in accordance with some embodiments of the present invention. In some embodiments, each of the building materials (such as tiles) comprises a portion of the image. Arranging the tiles according to their respective portion and/or location of the image, the tiles form the decorative surface of a wall with the completed image. The method 300 can start at a Step 302.

At a Step 304, an image (e.g., a picture, a drawing, a graphic design, a graphic pattern) is inputted to a computing device/web based program. The input can be performed by using an image scanner or a camera at a Step 304A.

At a Step 306, the image is divided into one or more zones in a grid (e.g., 3×3, 4×6). At a Step 307, the size and location of the image is adjusted. In some embodiments, the image is imposed with another background image. In other embodiments, the image is processed and combined with another image. A person of ordinary skill in the art appreciates that any graphic design and image process are able to be used to process the image or graphic designs.

At a Step 308, a reference number is assigned to each of the zones. The numbers can be assigned based on their respective location on the grid. For example, the column number can be sequenced based on an alphabetical order and the row number can be sequenced based on a numerical order. In such case, the third column and second row zone with the respective portion of the image can be numbered as C2 tile. The number can be subsequently used as a guide to arrange the zones of image/tiles to form a wall having the predetermined image.

At a Step 310, the respective portion of the image of a zone is printed on a blank coated tile.

At a Step 312, a reference number to each of the tiles based on the respective position of the zones on the grid , such that the tiles can be put together to form a wall with the image. The method 300 can step at a Step 314.

### Embodiment 1

An anti-corrosive, wear-resistant, and UV blocking/absorbing coating for dye sublimation comprises the following compositions by weight (kg): 91% of polyurethane resin, 2% of inorganic nano silicon oxides having a particle size of 200 nm, 2% of inorganic nano aluminum oxides having a particle size of 200 nm, 2% of inorganic nano zirconium oxides having a particle size of 200 nm, about 2% of a leveling agent, a defoamant 0.3-1%, and a thermal and UV hardner.

The preparation method thereof includes the following steps: preparing polyurethane resin; adding the above-mentioned amounts of inorganic nano silicon oxides, inorganic nano aluminum oxides, and inorganic nano zirconium oxides into the polyurethane; and mixing them together.

The preparation method thereof further includes printing a designed pattern on the aforesaid coating for dye sublimation with a transfer ink, and transferring the pattern onto a surface of an object under a temperature of 180° C. and a pressure of 0.5 Kpa/s for 180 seconds, thereby completing the printing.

### Embodiment 2

An anti-corrosive, wear-resistant, and UV blocking/absorbing coating for dye sublimation comprises the following compositions by weight (kg): 85% of polyurethane, 3% of inorganic nano silicon oxides having a particle size of 150 nm, 3% of inorganic nano aluminum oxides having a particle size of 150 nm, 3% of inorganic nano zirconium oxides having a particle size of 150 nm, and about 2% of a leveling agent, a defoamant 0.3-1%, and a thermal and UV hardner.

The preparation method thereof includes the following steps: preparing polyurethane; adding the above-mentioned amounts of inorganic nano silicon oxides, inorganic nano aluminum oxides, and inorganic nano zirconium oxides into the polyurethane; and mixing the them.

The preparation method thereof further includes printing a designed pattern on the aforesaid coating for dye sublimation with a transfer ink, and transferring the pattern onto a surface of an object under a temperature of 200° C. and a pressure of 1 Kpa/s for 150 seconds, thereby completing the printing.

### Embodiment 3

An anti-corrosive, wear-resistant, and UV blocking/absorbing coating for dye sublimation comprises the following compositions by weight (kg): 80% of polyurethane, 4% of inorganic nano silicon oxides having a particle size of 15 nm, 4% of inorganic nano aluminum oxides having a particle size of 15 nm, and 4% of inorganic nano zirconium oxides having a particle size of 15 nm, about 2% of a leveling agent, a defoamant 0.3-1%, and a thermal and UV hardner.

The preparation method thereof includes the following steps: preparing polyurethane; adding the above-mentioned amounts of inorganic nano silicon oxides, inorganic nano aluminum oxides, and inorganic nano zirconium oxides into the polyurethane; and mixing the them.

The preparation method thereof further includes printing a designed pattern on the aforesaid coating for dye sublimation with a transfer ink, and transferring the pattern onto a surface of an object under a temperature of 160° C. and a pressure of 1.5 Kpa/s for 300 seconds, thereby completing the printing.

### Embodiment 4

An anti-corrosive, wear-resistant, and UV blocking/absorbing coating for dye sublimation comprises the following compositions by weight (kg): 70% of polyurethane, 0.4% of inorganic nano silicon oxides having a particle size of 10 nm, 0.4% of inorganic nano aluminum oxides having a particle size of 10 nm, 0.4% of inorganic nano zirconium oxides having a particle size of 10 nm, and about 2% of a leveling agent, a defoamant 0.3-1%, and a hardner.

The preparation method thereof includes the following steps: preparing polyurethane; adding the above-mentioned amounts of inorganic nano silicon oxides, inorganic nano aluminum oxides, and inorganic nano zirconium oxides into the polyurethane; and mixing the them.

The preparation method thereof further includes printing a designed pattern on the aforesaid coating for dye sublimation with a transfer ink, and transferring the pattern onto a surface of an object under a temperature of 150° C. and a pressure of 1.0 Kpa/s for 300 seconds, thereby completing the printing.

### Embodiment 5

An anti-corrosive, wear-resistant, and UV blocking/absorbing coating for dye sublimation comprises the following compositions by weight (kg): 99% of polyurethane, 1% of inorganic nano silicon oxides having a particle size of 50 nm, 0.5% of inorganic nano aluminum oxides having a particle size of 50 nm, and 0.5% of inorganic nano zirconium oxides having a particle size of 50 nm.

The preparation method thereof includes the following steps: preparing polyurethane; adding the above-mentioned amounts of inorganic nano silicon oxides, inorganic nano aluminum oxides, and inorganic nano zirconium oxides into the polyurethane; and mixing the them.

The preparation method thereof further includes printing a designed pattern on the aforesaid coating for dye sublimation with a transfer ink, and transferring the pattern onto a surface of an object under a temperature of 210° C. and a pressure of 0.3 Kpa/s for 120 seconds, thereby completing the printing.

### Embodiment 6

It is similar to EMBODIMENT 1, except for that the dye sublimation is performed under a temperature of 100° C. and a pressure of 0.5 Kpa/s for 30 seconds.

### Embodiment 7

It is similar to EMBODIMENT 1, except for that the dye sublimation is performed under a temperature of 260° C. and a pressure of 1.5 Kpa/s for 1200 seconds.

### Embodiment 8

In the present invention, for comparing to the existing thermal transfer films, experiments are carried out by following the conventional method for comparative purpose. The results show that, the coatings of the present invention enhances the ability in wear-resistance and scratch-resistance by 30%, the ability in anti-corrosion by 20%, and the effect of UV protection by 30-50%.

### Embodiment 9

The present invention provides an application of the anti-corrosive, wear-resistant, and UV blocking/absorbing coating for dye sublimation according to the mentioned embodiment onto a product made of glass, ceramics, metal, crystal, plastic, leather, textile fabrics, wood, coated paper and the like.

The description is presented to enable one of ordinary skill in the art to make and use the invention. Various modifications to the described embodiments are readily apparent to those persons skilled in the art and the generic principles herein can be applied to other embodiments. Thus, the present invention is not intended to be limited to the embodiments shown but is to be accorded the widest scope consistent with the principles and features described herein. It is readily apparent to one skilled in the art that other modifications can be made to the embodiments without departing from the spirit and scope of the invention as defined by the appended claims.

What is claimed is:

1. A dye sublimation coating comprising a compositions in parts by weight: 70 to 99 parts of polyurethane, 0.4 to 10 parts of inorganic nano silicon oxides, 0.3 to 10 parts of inorganic nano aluminum oxides, and 0.3 to 10 parts of inorganic nano zirconium oxides.

2. The dye sublimation coating of claim 1, wherein the inorganic nano silicon oxides, the inorganic aluminum oxides, or the inorganic zirconium oxides comprise ultra-fine particles with a particle size of 200 nm or less.

3. The dye sublimation coating of claim 1, wherein the inorganic nano silicon oxides, the inorganic aluminum oxides, or the inorganic zirconium oxides comprise ultra-fine particles with a particle size of 15 nm or less.

4. The dye sublimation coating of claim 1, further comprising an amount of water as a solvent.

5. The dye sublimation coating of claim 1, further comprising an amount of an organic solvent.

6. The dye sublimation coating of claim 5, wherein the organic solvent comprises alcohol, toluene, xylene, acetone, cyclohexanone, or butanone.

7. The dye sublimation coating of claim 6, wherein the alcohol comprises ethanol, propanol, propanediol, or iso-propanol.

8. The dye sublimation coating of claim 1, comprising compositions in parts by weight: 80 to 90 parts of polyurethane, 0.4 to 4 parts of inorganic nano silicon oxides, 0.4 to 4 parts of inorganic nano aluminum oxides, and 0.4 to 4 parts of inorganic nano zirconium oxides.

9. A dye sublimation system comprises a polymer based coating on a building material.

10. The system of claim 9, further comprises a transparent film or a paper with a predetermined image in a sublimation dye.

11. The system of claim 9, further comprises a first computing device coupling with a second computing device, wherein the first computing device is at a manufacturing side and the second computing device is at a design generating side.

12. The system of claim 9, further comprising a coating device.

13. The system of claim 9, further comprising a dye sublimation oven.

14. The system of claim 9, further comprising a printer configured to print a sublimation dye.

15. A method of making a dye sublimation product comprising:
a) preparing polyurethane;
b) forming a dye sublimation coating composition by mixing 0.4 to 10 parts inorganic nano silicon oxides, 0.3 to 10 parts of inorganic nano aluminum oxides and 0.3 to 10 parts of inorganic nano zirconium oxides with 70 to 99 parts of the polyurethane; and
c) forming a coated object by applying a layer of the dye sublimation coating composition to an object.

16. The method of claim 15, wherein the dye sublimation coating comprises a property of anti-corrosive, wear-resistant, UV blocking, UV absorbing, UV retardant, or a combination thereof.

17. The method of claim 15, further comprising forming an ink layer with an sublimation dye having a pattern printed thereon, wherein the pattern is transferred to the coating via a dye sublimation process after being hot-pressed.

18. The method of claim 15, further comprising:
a) printing a designed pattern on the coated object for dye sublimation with a transferable ink; and
b) transferring the designed pattern onto a surface of the coated object to complete the dye sublimation, wherein the transferring is performed under a temperature of 100 to 260° C. and a pressure of 0.5 to 1.5 Kpa/s for 30 to 1200 seconds.

19. The method of claim 15, wherein the object comprises a glass, ceramics, a plastic, or a metal.
